(19) United States
(12) Patent Application Publication
(10) Pub. No.: US 2020/0007981 A1
(43) Pub. Date: Jan. 2, 2020

(54) Method for generating a sound data set for output through a loudspeaker of a motor vehicle

(71) Applicant: Ford Global Technologies, LLC, Dearborn, MI (US)

(72) Inventor: Julius Maximilian Engelke, Aachen (DE)

(73) Assignee: Ford Global Technologies, LLC, Dearborn, MI (US)

(21) Appl. No.: 16/457,558

(22) Filed: Jun. 28, 2019

(30) Foreign Application Priority Data
Jun. 29, 2018 (DE) 102018210783.1

(51) Int. Cl. H04R 3/00

(52) U.S. Cl. CPC H04R 3/00; H04R 2499/13

(57) ABSTRACT

The invention relates to a method for generating a sound data set (GS) for output through a loudspeaker (18) of a motor vehicle, having the steps of:
selecting a first partial sound data set (TGS1) indicative of a repeating tone sequence,
selecting a second partial sound data set (TGS2) indicative of a tone sequence free from repetitions,
varying the second partial sound data set (TGS2), and combining the first partial sound data set (TGS1) and the second partial sound data set (TGS2) in order to obtain the sound data set (GS).

The invention relates to a method for generating a sound data set for output through a loudspeaker of a motor vehicle.

The internal sounds of a motor vehicle and the sound emitted from the motor vehicle into the surroundings play a big role for the impression of quality of a motor vehicle.

The sounds emitted by a motor vehicle can either have a conventional/mechanical origin, such as for example the thud of a door, or have a synthetic origin such as, for example, an audio sample that is played through a loudspeaker while a button is pressed.

The majority of sounds with conventional origin sound a little different from time to time. A slow or fast closing of a vehicle door, for example, leads to different sounds. This is understandable, since a complex set of parameters such as, for example, mechanical forces, temperature, the NVH properties etc. influence the sound generation. People unconsciously perceive these repeated sounds, slightly changed every time, as natural.

Sounds of a motor vehicle with synthetic origin, however, are usually only played through a loudspeaker of the motor vehicle, and sound exactly the same every time. The result is that these sounds are perceived as unnatural or synthetic. Synthetic sounds can be desirable in a few cases, such as for example HMI warning or information tones, but on most occasions a natural sound environment inside and around the motor vehicle is perceived as of higher quality.

Above all in the case of electrified motor vehicles with an electric motor, which scarcely generates engine sounds, as the traction motor, synthetic sounds play an even greater role for the perception by other traffic participants such as pedestrians or cyclists than in the case of motor vehicles with internal combustion engines as the traction motor.

Synthetic sounds, however, typically sound unnatural or synthetic, and appear monotonous since the sound or timbre does not vary with each repetition/replay.

It is therefore the object of the invention to provide a method with which synthetic sounds can be given a naturally varying character.

The object is achieved by a method for generating a sound data set for output through a loudspeaker of a motor vehicle, with the steps of:

selecting a first partial sound data set indicative of a repeating tone sequence,
selecting a second partial sound data set indicative of a tone sequence free from repetitions,
varying the second partial sound data set, and
combining the first partial sound data set and the second partial sound data set in order to obtain the sound data set.

A tone sequence here refers to a characteristically ordered temporal sequence of tones. The tone sequence can comprise a melody. The tones of the tone sequence can be individual tones or a mixture of tones consisting of tones of different frequencies. Tones can be described through parameters such as tone pitch, tone duration, volume or tone strength and sound or timbre. Timbre (determined, amongst other things by the ratio of the partial tone amplitudes to one another) here refers to a mixture of the fundamental tone, overtones and noise components, as well as the temporal profile of this spectrum and the volume.

The first partial sound data set thus represents a fixed sequence of tones with a predetermined time duration after which the tone sequence repeats itself. The second partial sound data set, in contrast, comprises a random sequence of tones, and is therefore free from repetitions.

The sound data set then acts as the basis for the generation of sounds, such as for example orientation sounds, which do not convey any particular message but which have properties that make them identifiable to a person and worthy of attention such as, for example, the rising sound of a motor vehicle such as a passenger car or truck.

The solution thus consists in using sounds that are generated dynamically and in part randomly and which are complex and non-repeating. An improved acceptance of synthetic noises in the motor vehicle is thus achieved, and the impression of quality of the motor vehicle is raised.

According to one embodiment, the first partial sound data set is based on a natural sequence of tones, and the second partial sound data set on a synthetic sequence of tones. The natural tone sequence can be a conventional audio sample. The tone sequence that is output on that basis sounds each time like a conventional audio play. The synthetic tone sequence, on the other hand, is a result of sound synthesis. A sound synthesis here refers to a method for the production of artificial sounds or the modification of natural sounds. Natural-seeming sounds can thus be varied particularly easily through combination with synthetic sounds, and no longer have a monotonous effect.

According to a further embodiment, at least one parameter of a sound synthesis is changed, making use of a random generator, to vary the second partial sound data set. Thus, by using random numbers that are made available by the random generator, the synthetic tone sequence is directly changed with an artificial character. A sound that does not have a monotonous effect is thus made available in a particularly simple manner.

According to a further embodiment, the at least one parameter is representative of a waveform of an oscillator, a factor of a mixer, a factor of a filter, a factor of an amplifier, a factor of a modulator, a factor of a modulation envelope curve and/or a factor of an envelope curve. The profile of the volume and/or the timbre of tones can thus be changed in a particularly simple manner.

A computer program product for carrying out a method of this sort, a device for generating a sound data set for output through a loudspeaker of a motor vehicle, and a motor vehicle with such a device furthermore belong to the invention.

The invention will now be explained with reference to a drawing. Here:

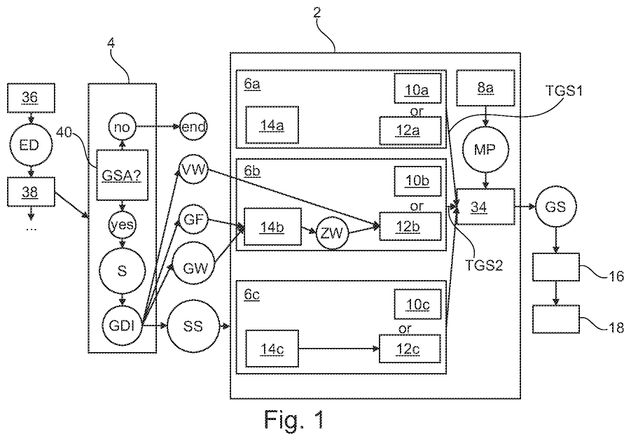

FIG. 1 schematically shows a device for generating a sound data set for output through a loudspeaker of a motor vehicle.

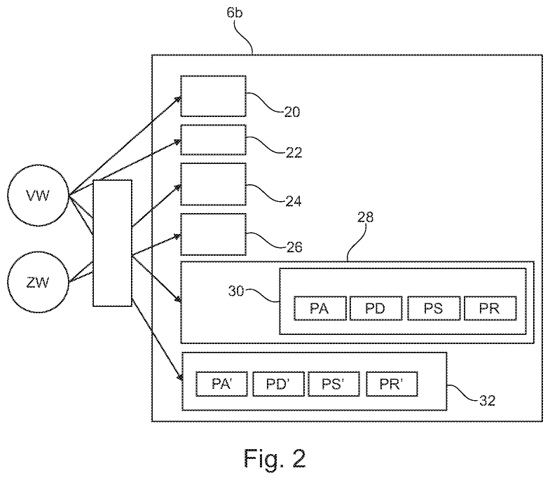

FIG. 2 schematically shows further details of the device represented in FIG. 1.

Reference is first made to FIG. 1.

A device 2 for generating a sound data set GS for output through a loudspeaker 18 of a motor vehicle is shown.

The motor vehicle can be a passenger car that has an electric motor as a traction motor and which therefore emits particularly little operating noise when in operation.

In other words, the sound data set GS serves as the basis for the generation of so-called orientation sounds. Orientation sounds refers to characteristic sounds which do not convey any particular message but which have properties that make them identifiable to a person and worthy of attention such as, for example, the rising sound of a motor vehicle such as a passenger car or truck.

The device 2 comprises a plurality of sound apparatuses 6a, 6b, 6c, a random generator 8a and an output mixer 34. In the present exemplary embodiment, the device 2 comprises three sound apparatuses 6a, 6b, 6c.

Each of the sound apparatuses 6a, 6b, 6c comprises in the present exemplary embodiment respectively a player apparatus 10a, 10b, 10c, a sound generator 12a, 12b, 12c, and a random generator 14a, 14b, 14c.

The device 2 is connected to a database 4 for data transfer, so that the device 2 can read sound data GD out of the database 4, as will be explained later in more detail.

Before starting operation of the device 2, a driver 36 can enter input data ED which are, for example, representative of his personal preferences, into the database 4 through an HMI 38 of the motor vehicle.

After commencement of operation, a module 40 of the database 4 checks whether a sound signal generation request GSA is present or not. If the sound signal generation request GSA is present, then the sound data GD corresponding to a predetermined sound S is selected.

The sound data GD comprise, in the present exemplary embodiment, predetermined values VW for a sequence of tones of, for example, natural origin, a weighting function GF and threshold values GW as well as a start signal SS. The weighting function GF and the threshold values GW are operating parameters of the random generator 14b, and specify thresholds for the random values ZW made available by the random generator 14b.

Of the three sound apparatuses 6a, 6b, 6c, only the sound apparatus 6a and the second sound apparatus 6b are active in the present exemplary embodiment, each respectively making available a first partial sound data set TGS1 and a second partial sound data set TGS2, which are mixed together in the output mixer 34 to form the sound data set GS.

In the present exemplary embodiment, the first partial sound data set TGS1 made available by the first sound apparatus 6a is based on a natural sequence of tones. The natural sequence of tones can be a conventional audio sample that is played through the active player apparatus 10a, such as for example a conventional audio player, while the sound generator 12a and the random generator 14a are inactive. The sound, or the timbre of this partial sound data set TGS1, or of the sequence of tones based thereon that is output, sounds each time like a conventional audio replay.

In contrast, the second partial sound data set TGS2 played by the second sound apparatus 6b is based in the present exemplary embodiment on a synthetic sequence of tones. In order to generate the second partial sound data set TGS2, the sound generator 12b and the random generator 14b in the present exemplary embodiment are active, while the player apparatus 10b of the second sound apparatus 6b is inactive.

While the predetermined values VW are transferred directly to the sound generator 12b, the weighting function GF and the threshold values GW are transferred to the random generator 14b. The weighting function GF and the threshold values GW are operating parameters of the random generator 14b, and specify thresholds for the random values ZW made available by the random generator 14b.

The random values ZW are then transferred to the sound generator 12b which then, on the basis of the predetermined values VW and the random values ZW, makes the second partial sound data set TGS2 available.

The output mixer 34 has adjustable mixing parameters MP such as, for example, a signal level ratio for the two partial sound data sets TGS1, TGS2. Values for the adjustable mixing parameters MP of the output mixer 34 are made available by the random generator 8a. The mixing of the two partial sound data sets TGS1, TGS2 can thus be varied in a random manner.

The sound data set GS is then amplified by a power amplifier 16 and output by the loudspeaker 18. The loudspeaker 18 then radiates sound into the surroundings of the motor vehicle in order thus to warn other traffic participants such as, for example, pedestrians or cyclists, of the approach of the motor vehicle.

Reference is now also made to FIG. 2.

The illustration shows that the predetermined values VW are fed to an oscillator 20, a mixer 22, a modulation module 28 with a modulation envelope curve module 30, and an envelope curve module 32, while the random values ZW are fed to a filter 24 and an amplifier 26 of the sound apparatus 6b.

In the present exemplary embodiment, the modulation envelope curve module 26 comprises adjustable parameters respectively for different phases of a simplified modulation envelope curve of a sound or tone such as, for example, attack PA, decay PD, sustain PS and release PR.

The envelope curve module 32 in the present exemplary embodiment also comprises adjustable parameters respectively for different phases of a simplified envelope curve of a sound or tone such as, for example, attack PA, decay PD, sustain PS and release PR.

Differing from the present exemplary embodiment, other forms of sound synthesis can also be used such as, for example, wavetable synthesis, granular synthesis or subtractive synthesis.

Wavetable synthesis refers here to an economical form of the generation of acoustic tones which is relatively easy to realize technically, for example with synthesizers or soundcards.

For this purpose a waveform of the sound or timbre that is to be generated later, for example the profile of the oscillation of a single tone of a particular tone pitch measured electrically by a microphone, the reference tone, is recorded. Usually this is middle C (c′). The measured waveform can then easily be turned back into the recorded tone by a loudspeaker. The replay speed may be changed here in appropriate cases, so that not only the pitch of the originally recorded tone can be played, but at any desired tone from the musical scale.

Granular synthesis is a method used in some synthesizers and programs to generate artificial sounds. A continuous sound which consists in reality of many individual parts is simulated here. These individual parts, the grains, are very short, digital sound fragments, whose length is usually less than 50 ms. The listener can recognize the fragment as an independent sound event if this limit is exceeded.

In subtractive synthesis, an oscillator (a VCO, for example) generates raw sound material which is then further processed by sound-modifying modules (filters, envelope curve generators, amplifier modules etc.). The desired sound or timbre is achieved in that the unwanted frequency components are filtered out or lowered (subtraction) from the spectrum of the oscillator which is usually rich in overtones.

In summary, dynamic and partially randomly generated sounds which are complex and non-repeating are thus made available, which leads to an improved acceptance of synthesized sounds in the motor vehicle and raises the impression of quality of the motor vehicle.

### LIST OF REFERENCE SIGNS

2 Device
4 Database
6a Sound apparatus
6b Sound apparatus
6c Sound apparatus
8a Random generator
10a Replay apparatus
10b Replay apparatus
10c Replay apparatus
12a Sound generator
12b Sound generator
12c Sound generator
14a Random generator
14b Random generator
14c Random generator
16 Power amplifier
18 Loudspeaker
20 Oscillator
22 Mixer
24 Filter
26 Amplifier
28 Modulation module
30 Modulation envelope curve module
32 Envelope curve module
34 Output mixer
36 Driver
38 HMI
40 Module
ED Input data
GD Sound data
GF Weighting function
GS Sound data set
GW Threshold values
MP Mixing parameters
PA Attack
PA′ Attack
PD Decay
PD′ Decay
PS Sustain
PS′ Sustain
PR Release
PR′ Release
S Sound
SS Start signal
TGS1 Partial sound data set
TGS2 Partial sound data set
VW Predetermined values
ZW Random values

1. A method for generating a sound data set (GS) for output through a loudspeaker (18) of a motor vehicle, of the method comprising:
selecting a first partial sound data set (TGS1) indicative of a repeating tone sequence,
selecting a second partial sound data set (TGS2) indicative of a tone sequence free from repetitions,
varying the second partial sound data set (TGS2), and
combining the first partial sound data set (TGS1) and the second partial sound data set (TGS2) in order to obtain the sound data set (GS).

2. The method as claimed in claim 1, wherein the first partial sound data set (TGS1) is based on a natural sequence of tones, and the second partial sound data set (TGS2) is based on a synthetic sequence of tones.

3. The method as claimed in claim 1, wherein, in order to vary the second partial sound data set (TGS2), at least one parameter of a sound synthesis is changed a random generator (14a, 14b, 14c).

4. The method as claimed in claim 3, wherein the at least one parameter is representative of one or more of a waveform of an oscillator (20), a factor of a mixer (22), a factor of a filter (24), a factor of an amplifier (26), a factor of a modulator (28), a factor of a modulation envelope curve (30), and/or a factor of an envelope curve (32).

5. (canceled)

6. A device (2) for generating a sound data set (GS) for output through a loudspeaker (18) of a motor vehicle, the device comprising:
a computer configured to:
select a first partial sound data set (TGS1) indicative of a repeating sequence of tones,
select a second partial sound data set (TGS2) indicative of a sequence of tones free from repetitions,
vary the second partial sound data set (TGS2), and
combine the first partial sound data set (TGS1) and of the second partial sound data set (TGS2) to form the sound data set (GS).

7. The device (2) as claimed in claim 6, wherein the first partial sound data set (TGS1) is based on a natural sequence of tones, and the second partial sound data set (TGS2) on a synthetic sequence of tones.

8. The device (2) as claimed in claim 6, wherein, in order to vary the second partial sound data set (TGS2), the device (2) is designed to change at least one parameter of a sound synthesis making use of a random generator (14a, 14b, 14c).

9. The device (2) as claimed in claim 8, wherein the at least one parameter is representative of one or more of a waveform of an oscillator (20), a factor of a mixer (22), a factor of a filter (24), a factor of an amplifier (26), a factor of a modulator (28), a factor of a modulation envelope curve (30). and/or a factor of an envelope curve (32).

10. The device (2) as claimed in claim 6, wherein the device (6) is incorporated into the motor vehicle.

11. A method, comprising:
determining, by one or more computers, a first partial sound data set indicative of a repeating tone sequence;
determining, by the one or more computers, a second partial sound data set indicative of a tone sequence free from repetitions;
varying, by the one or more computers, the second partial sound data set;
combining, by the one or more computers, the first partial sound data set and the second partial sound data set in order to obtain a sound data set; and
outputting, by the one or more computers, the sound data set through a loudspeaker of a motor vehicle.

12. The method of claim 11, wherein the first partial sound data set is based on a natural sequence of tones, and the second partial sound data set is based on a synthetic sequence of tones.

13. The method of claim 11, wherein, in order to vary the second partial sound data set, at least one parameter of a sound synthesis is changed using a random generator.

14. The method of claim 13, wherein the at least one parameter is representative of one or more of a waveform of an oscillator, a factor of a mixer, a factor of a filter, a factor of an amplifier, a factor of a modulator, a factor of a modulation envelope curve, and/or a factor of an envelope curve.
